(19) United States
(12) Patent Application Publication
(10) Pub. No.: US 2007/0150947 A1
(43) Pub. Date: Jun. 28, 2007

(54) Method and apparatus for enhancing security on an enterprise network

(75) Inventors: Rajesh Vijayakumar, San Jose, CA (US); Vibhu Vivek, Freemont, CA (US); Biju Kunjukunju, Cupertino, CA (US); Niklas Hanberger, Stockholm (SE)

Correspondence Address: JOHN C. GORECKI, ESQ., P.O BOX 553, CARLISLE, MA, 01741, US

(73) Assignee: Nortel Networks Limited, St. Laurent (CA)

(21) Appl. No.: 11/315,823

(22) Filed: Dec. 22, 2005

(51) Int. Cl. G06F 12/14

(52) U.S. Cl. 726/17

(57) ABSTRACT

Increased security may be provided on an enterprise network by causing a central security server to administer security policy on the network. Agents in hosts on the network authenticate with the central security server to obtain policy information for that particular host user. The policy information may specify whether any special routing, processing, or other features, should occur in connection with particular classes of traffic or in connection with communications with particular other hosts or classes of hosts. In operation, the agents implement the policy by interfacing with the networking layer to cause the traffic to be routed via any other host/server on the network so that appropriate services may occur with respect to that traffic. Additionally, tunnels may be established so that traffic in-between hosts or between a host and server to be encrypted, compressed, or otherwise treated as specified in the policy.

### BACKGROUND OF THE INVENTION

1. Field of the Invention

The present invention relates to communication networks and, more particularly, to a method and apparatus for enhancing security on an enterprise network.

2. Description of the Related Art

Data communication networks may include various routers, switches, bridges, hubs, and other network devices coupled to and configured to pass data to one another. These devices will be referred to herein as “network elements.” Data is communicated through the data communication network by passing protocol data units, such as Internet Protocol (IP) packets, Ethernet Frames, data cells, segments, or other logical associations of bits/bytes of data, between the network elements by utilizing one or more communication links between the devices. A particular protocol data unit may be handled by multiple network elements and cross multiple communication links as it travels between its source and its destination over the network.

It is common for an enterprise, such as a corporation, educational institution, government, or other type of association, to have a communication network established over which individuals working for the enterprise or associated with the enterprise may transmit data. Enterprise networks are commonly referred to as Local Area Networks (LANs). Access to a LAN is generally restricted, so that only those users that have authenticated themselves to the network and are authorized to obtain access to the network are allowed to communicate over the network and use resources available on the network.

Since access to an enterprise network is restricted, communications within the network are generally viewed as relatively secure. Outside of the network, this is not necessarily the case and, hence, Virtual Private Networks (VPNs) have been developed. VPNs provide a way of creating tunnels through an untrusted network such as the Internet so that network users may be connected to an enterprise network in a secure manner and so that different portions of the enterprise network may be connected together securely.

Although VPN tunnels are commonly used outside of an enterprise network, these tunnels stop at the edge of the network, typically at a VPN gateway or other type of network element specifically configured to implement VPN tunnels into and out of the enterprise network. Within the network, however, communications are generally not secured. As enterprises become larger, with larger numbers of individual users, it may be advantageous to increase the security level within the enterprise network, so that particular users or classes of users may communicate on the network without allowing those communications to become visible to other network users.

### SUMMARY OF THE INVENTION

The present invention overcomes these and other drawbacks by providing a method and apparatus for increasing the security level of an enterprise network. According to an embodiment of the invention, a central security server is provided to administer policy on the network. Agents in hosts on the network authenticate with the central security server to obtain policy information for a host user. The policy information may be specific to the user and specify whether any special routing, processing, or other features, should occur in connection with particular classes of traffic or in connection with communications with particular other hosts or classes of hosts. In operation, the agents implement the policy by interfacing with the networking layer to cause the traffic to be handled appropriately on the network. Network traffic between particular hosts may thus be routed via any other host/server on the network so that appropriate services may occur with respect to the traffic between the hosts. Additionally, tunnels may be established between hosts on the enterprise network to enable traffic in-between particular hosts or between a host and server to be encrypted, compressed, or otherwise treated as specified in the policy.

### BRIEF DESCRIPTION OF THE DRAWING

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example communication network that may be used to implement an embodiment of the invention;

FIG. 2 is a functional block diagram of a central security server according to an embodiment of the invention; and

FIG. 3 is a functional block diagram of a host according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

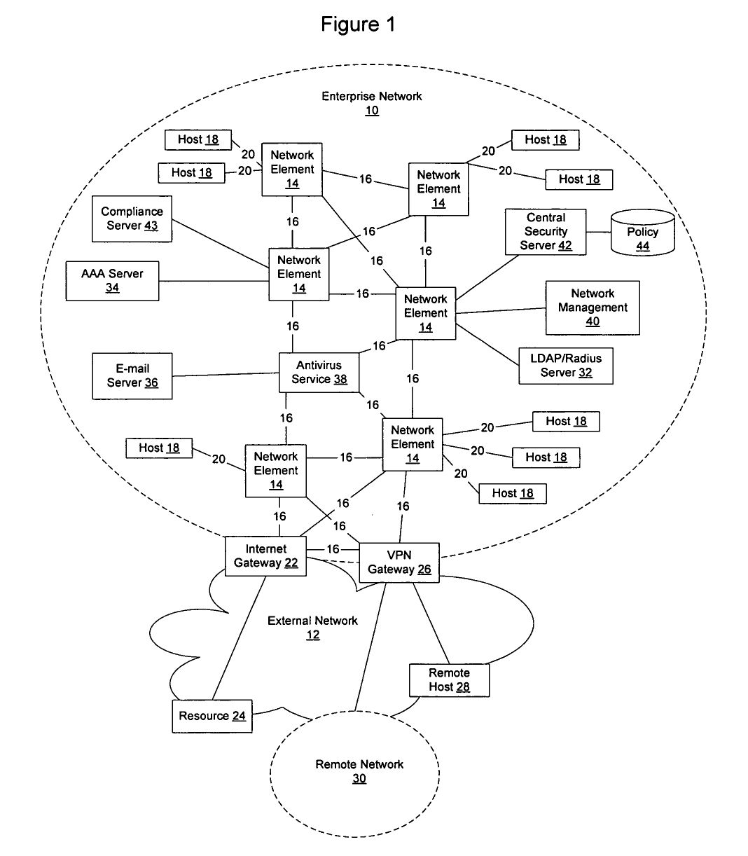

FIG. 1 shows an example enterprise network 10 connected to an external network 12. The enterprise network 10 may be an Ethernet network or may be formed using any number of other LAN technologies. The external network may be the Internet, another network domain, or another network. The invention is not limited to the use of particular types of networks to implement the enterprise and/or public network.

The enterprise network 10 includes a plurality of network elements such as routers or switches 14 interconnected by links 16. Hosts 18 connect to the network elements over links 20 which may be the same as links 16 or may be lower speed links than the links 16 used to interconnect the network elements. Although a particular enterprise network example has been provided, the invention is not limited to the particular example illustrated in FIG. 1.

The enterprise network 10 may also include servers configured to provide particular services on the network. For example, the network may include an Internet gateway 22 configured to provide Internet access to hosts 18 over the network 10, so that hosts on the enterprise network may access resources 24 available over the Internet. The Internet gateway 22 may be connected to or associated with a VPN gateway 26 configured to provide VPN services to remote hosts 28 and remote networks 30 so that communications may be exchanged securely between the enterprise network 10 and the remote host 28 or remote network 30. Internet gateways and VPN gateways are well known and the invention is not limited to the use of particular network elements to connect the enterprise network 10 with the external network 12.

The network also may include an LDAP/Radius server 32 configured to provide remote access to the network, e.g. to enable remote host 28 to log onto the enterprise network 10. The network may also have an AAA server 34 configured to authenticate users logging onto the network and determine whether the users are authorized and, optionally, an authorization level of the user.

Where e-mail services and other services are to be provided on the network, the network may also include an e-mail server 36 configured to provide e-mail services to users on the network. The e-mail server may, for example, be an SMTP server, although the invention is not limited in this manner. The network may also include an antivirus service 38, which may be located on a separate server or implemented on one or more of the network elements 14. The antivirus service may be configured to enable traffic flowing on the network to be scanned for viruses, Trojan horses, worms, and other malicious code, to prevent the code from reaching its ultimate destination on the network. By filtering the traffic at the network level, it is possible to stop the spread of an infection caused by the malicious code without relying on the end points e.g. hosts., to do so on their own.

A network management station 40 may be included to enable a network manager to set policy on the network. Additionally, according to an embodiment of the invention, a central security server 42 is provided on the network to control how hosts on the network communicate. The central security server 42 may enable policy, set by the network management server 40, to be applied to particular types of communication, particular users, and particular classes of users, so that communications within the network are able to be handled in particular ways on the network. For example, the central security server 42 may cause traffic to be routed through particular network elements on the network, for the traffic to be encrypted, for the traffic to be compressed, for the traffic to pass through a server implementing a service such as the antivirus service 38, and for numerous other types of actions to occur with respect to the traffic on the network. The policies may be applied for individual users, communications between particular sets of hosts, or on any other granular basis.

When a host connects to the network, depending on the manner in which the connection occurs, the host will communicate with the LDAP/Radius server 32 and/or the AAA server 34 to perform standard authentication and authorization procedures. Optionally, a computer configuration verification process may be performed as well, such as to determine whether the host computer has the proper antivirus files, authorized versions of applications, and otherwise is correctly configured.

To enable communications to take place in other than standard fashion on the enterprise network 10, the user may also initiate an exchange with the central security server 42 to enable user-specific policy to be applied to the manner in which the user's data is handled by the network. Optionally, the login process between the host and the security server may be handled by the AAA server, so that the login process is able to reuse at least some of the information that was previously exchanged between the host and the AAA server in connection with accessing the network.

When the host logs into the central security server, an agent at the host obtains a set of policies for the user that are to be applied to traffic for that user. The policies, as mentioned above, may be set by the network administrator via the network management station 40. Optionally, the policies may also be set by the user so that the user has control over how communications will be handled by the underlying network.

Where two different hosts have specified conflicting policies as to how particular communications are to be handled, the central security server 42 may resolve the conflict according to conflict resolution policies implemented by the network administrator. For example, the network administrator may specify that the more restrictive of the two conflicting policies may be implemented. The invention is not limited to a particular way of handling conflict resolution.

The central security server maintains a policy database 44 of rules populated by the network manager via the network management server 40, and optionally as input by the users. The rules may be globally applicable, may be host specific, or may be user specific. Many different types of rules may be applied. To help illustrate an example of how the rules may affect traffic on the network, several examples will be provided. The invention is not limited to these particular examples, however as other rules may be used as well.

### EXAMPLE 1

### Encrypted e-mail

A user may determine that all e-mail they receive should be encrypted, so that their e-mail cannot be read by anyone else on the network. Alternatively, a network administrator may determine that e-mail between particular users should be encrypted so that it is not visible to other users on the network. For example, a Chief Executive Officer (CEO) of a company may prefer that employees maintaining the e-mail database not be able to read e-mail communications or instant messaging communications regarding a pending sale of the corporation. According to an embodiment of the invention, the user or a network administrator may set a policy in the central security server 42 to cause e-mail traffic sent by the CEO or addressed to the CEO to be encrypted between the host and the e-mail server 36, and between the e-mail server 36 and the other host(s) associated with the e-mail.

The central security server, in connection with encryption, may participate in causing the parties to exchange keys so that standard key-based security may be used. Additionally, the central security server may serve as a certificate authority so that certificate based authentication may be used internally on the enterprise network 10. The invention is not limited to a particular manner in which encryption is to be implemented on the network as many different types of encryption may be used in connection with embodiments of the invention.

### EXAMPLE 2

### Tunneling Data

VPNs are commonly used external to an enterprise network. However, internally, data generally is not secured. Particular departments, such as human resources, may have access to personnel employment records, reviews, salary information, and other sensitive information that may be required to be maintained in confidence. While it is possible to have a separate domain created for the personnel in that department, it may be easier to simply cause internal communications between members of the Human Resources (HR) department to be tunneled across the internal network. According to an embodiment of the invention, the central security server 42 may specify compression, encryption, and routing for use in connection with HR personnel to enable tunnels to be created between hosts being used by the HR personnel on the enterprise network 10. These policies may then be passed to agents on the hosts when the hosts log into the central security server, so that the policies may be implemented on the network.

### EXAMPLE 3

### Antivirus

When a host user logs into a network, a compliance check may be performed on the host computer by a compliance server 43 to determine whether the host computer has the proper software profile. As one part of this check, the compliance check may determine if the host computer has sufficient antivirus, antispam, anti-spyware, and other types of protective software loaded on the computer. If the compliance check determines that there is insufficient protective software loaded and/or running on the host computer, the central security server 42 may set a rule that all communications from the host are required to pass through an antivirus service 38. At the network level, this may be implemented by causing data to be routed from the host to the antivirus service before being transmitted to the ultimate destination on the network. Other traffic, however, from trusted hosts may continue to be transmitted directly without passing through the antivirus service. Thus, antivirus services may be provided only to those flows deemed to be more likely to carry malicious code, while allowing other flows to be transported through the network without passing through the antivirus service. This allows the antivirus service to be used for only those flows more likely to contain viruses to minimize disruption on other flows and minimize the amount of traffic that must be processed by the antivirus service 38.

As is apparent from the several examples, there are many ways to use the central security server in connection with an embodiment of the invention. Accordingly, the invention is not limited to an embodiment that operates in one particular fashion to implement one particular feature, but rather provides a platform to enable multiple different security features to be applied to different types of traffic on a network.

The central security server maintains lists of policies for particular users and groups of users in the policy database 44. When the user logs onto the network, the list of policies for the user will be retrieved and passed to an agent resident on the host associated with that user. Since the policies to be applied are specific to the user rather than the host, the policies follow the user through the network regardless of where the user has connected to the network.

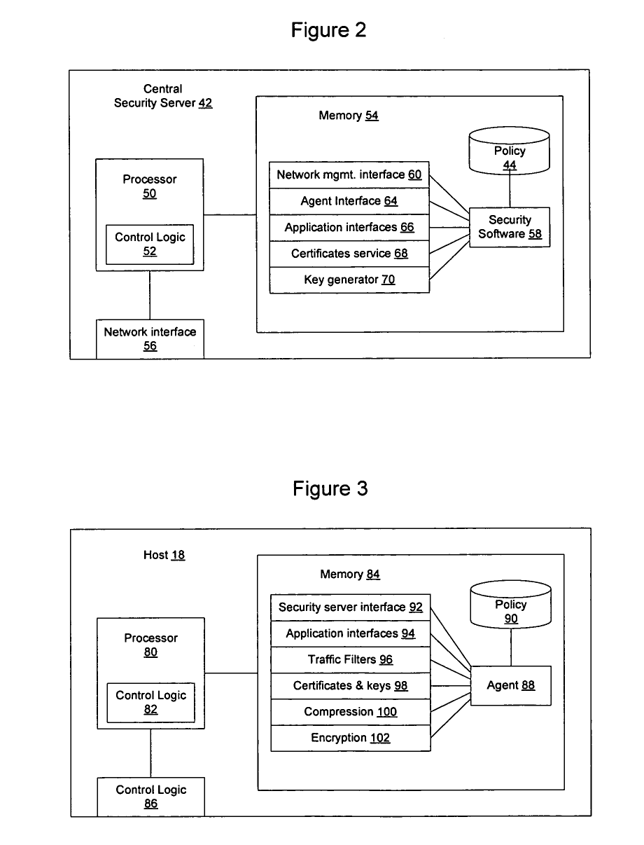

FIG. 2 illustrates an example of a central security server 42 that may be used to implement an embodiment of the invention. As shown in FIG. 2, the central security server of this embodiment includes a processor 50 configured to implement control logic 52 that may be stored in memory 54. The central security server interfaces the network 10 via network interface 56. Other common components commonly provided on server computer platforms may be used to implement the central security server 42 as well.

The memory 54 contains one or more functional modules implemented in software that may enable the security server 42 to perform the functions ascribed to it herein. Although an embodiment in which software is used to implement the functions of the central security server will be described, the invention is not limited in this manner as hardware, firmware, or a combination of these several technologies may also be used to implement some or all of the functions of the central security server 42.

In the embodiment shown in FIG. 2, the central security server includes security software 58 configured to enable the central security server to function on the network. For example, the central security software may include a network management graphical user interface, command line interface, or other interface 60 to enable it to be accessed by a network manager via a network management station. As described above, the network manager will use the network management interface to set policies to be implemented by the central security server 42 and which will be stored in a policy database 44.

The central security server may also include an agent interface 64 configured to enable the security software to pass the policies to the agents implemented in the hosts 18. Additionally, where the central security server is to interact with other servers such as the AAA server 34, compliance server 43, and/or LDAP/RADIUS server 32, the central security server may include an application interface 66 configured to enable it to exchange information with these other servers, for example to cooperatively determine the identity of the user associated with the host 18 and to determine what policies should be passed to the agent on the host to enable the host to implement the requisite security features on the network.

Optionally, the central security server may include a certificate service 68 and/or key generator 70 to enable the security server to act as a certificate server and to enable the central security server to generate keys for use in encrypting traffic on the network 10. The invention is not limited in this manner, however, as these services may be provided by other components on the network and interfaced to the central security server as required. The central security server may also include other components as well and the invention is not limited to an embodiment that includes only these several functional modules.

FIG. 3 illustrates an example of a host 18 that may be used to implement an embodiment of the invention. As shown in FIG. 3, the host 18 of this embodiment includes a processor 80 configured to implement control logic 82 that may be stored in memory 84. The host interfaces the network 10 via network interface 86. Other common components may be used to implement the host 18 as well, as is well known in the art.

The memory 84 contains one or more functional modules implemented in software that may enable the host 18 to perform the functions ascribed to it herein. Although an embodiment in which software is used to implement the functions of the host will be described, the invention is not limited in this manner as hardware, firmware, or a combination of these several technologies may also be used to implement some or all of the functions of the host 18.

In the embodiment shown in FIG. 3, the host includes an agent 88 configured to implement the policies received from the security server 42. The policies may be stored in a policy database 90.

The agent may interact with the central security server via a central security server interface 92 and with other applications running on the host 18 via application interfaces 94. The application interfaces 94 allow, for example, the applications running on the host to specify particular attributes that should be used for communications on the network.

The policies may specify traffic filters 96, certificates and keys 98, compression algorithms 100, encryption algorithms 102, and other aspects that may be used in connection with traffic to be transmitted onto or received from the network 10. The host 18 may also include other functional modules as well and the invention is not limited to an embodiment that implements all of these or only these functional modules.

The functions described above may be implemented as a set of program instructions that are stored in a computer readable memory within the host 18 or security server 62 and executed on one or more processors within those computers. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A communication network comprising:
a network management station, a central security server, and a plurality of hosts, each of said hosts implementing a security agent, wherein the network management station is configured to interface a network manager to enable the network manager to specify policy to be used in connection with defining aspects of communications between the hosts on the communication network, the central security server is configured to receive the policy from the network management station and store the policy, and the security agents in the hosts are configured to retrieve at least a portion of the policy from the central security server and implement the retrieved portion of the policy in connection with traffic to be transmitted on the network.

2. The communication network of claim 1, wherein the policy specified by the network manager comprises a plurality of policies, at least a first group of said policies being specific to particular users of the communication network.

3. The communication network of claim 2, wherein the hosts are configured such that when one of said users logs into a host, the host is configured to retrieve a subset of the policies specific to that particular user.

4. The communication network of claim 2, wherein the policies specify routing for particular types of traffic associated with particular users of the network.

5. The communication network of claim 1, wherein the agents are configured to enable Virtual Private Network (VPN) tunnels to be established between hosts on the network.

6. The communication network of claim 5, wherein the communication network is an Ethernet network.

7. The communication network of claim 5, wherein the communication network is an enterprise network, the communication network further comprising an Internet gateway configured to connect the enterprise network with the Internet.

8. The communication network of claim 7, wherein the VPN tunnels are established between hosts on the enterprise network.

9. A method of enhancing security by a host on a network, the method comprising the steps of:
establishing a connection by a host to a network;
transmitting first authentication information associated with an user to the network to obtain access to the network;
transmitting second authentication information associated with the user to a central security server to obtain a set of security policies applicable to the user for use in connection with communications by the user on the network; and
using the security policies by the host to format data to be transmitted to other hosts on the network.

10. The method of claim 9, wherein the network is an enterprise network, and wherein the step of using the security policies comprises participating in a Virtual Private Network (VPN) tunnel between the host and another host on the network.

11. The method of claim 9, wherein the step of using the security policies comprises encrypting the data.

12. The method of claim 9, wherein the security policies comprise routing information.

13. The method of claim 9, wherein the security policies are application specific to enable the host to use different security policies depending on the application that generated the data to be transmitted on the network.

14. A method of enhancing security by a central security server on a network, the method comprising the steps of:
receiving, from a host, a request for policies applicable to a user associated with the host;
retrieving a set of policies applicable to the user;
transmitting the set of policies to the host;
wherein the set of policies enable attributes associated with communications to be specified between the host and other hosts on the network on a host-by-host basis.

15. The method of claim 14, wherein the policies enable a Virtual Private Network (VPN) tunnel to be established between the host and at least one of the other hosts on the network.

16. The method of claim 14, wherein the policies enable routing information to be specified for communications between the host and at least one of the other hosts on the network.

17. The method of claim 14, wherein the network is an enterprise network.
